(19) United States
(12) Patent Application Publication
(10) Pub. No.: US 2006/0282178 A1
(43) Pub. Date: Dec. 14, 2006

(54) System and method for solving equality-constrained quadratic program while honoring degenerate constraints

(75) Inventors: Indraneel Das, Manchester, CT (US); Gonzalo Rey, Clarence Center, NY (US)

Correspondence Address: CARLSON, GASKEY & OLDS, P.C., 400 WEST MAPLE ROAD, SUITE 350, BIRMINGHAM, MI, 48009, US

(73) Assignee: United Technologies Corporation

(21) Appl. No.: 11/150,949

(22) Filed: Jun. 13, 2005

(51) Int. Cl. G05B 13/02

(52) U.S. Cl. 700/28; 700/29

(57) ABSTRACT

A system and method more accurately solves equality-constrained a quadratic program without significantly increasing computational load. The solver can be used to iteratively determine the solution to a general quadratic program via an active set method. The algorithm determines which of the equality constraints are binding and which constraints are not. The non-binding constraints are dropped from the active set and the objective function improved. The non-binding constraints are identified based upon the signs of the Lagrange multipliers of the equality constraints. The algorithm determines the optimization variables and the Lagrange multipliers independently of one another based upon a single matrix factorization.

### BACKGROUND OF THE INVENTION

The present invention relates to on-board optimization techniques for on-board control, and is particularly useful for Model Predictive Control of a dynamical system.

This invention describes a significant enhancement to existing optimization techniques for on-board control. On-board Model Predictive Control of a nonlinear dynamical system often involves linearizing the nonlinear dynamics and posing a Quadratic Program to stay close to a desired profile of outputs. Since on-board control requires computing a reliable solution in a robust manner in real-time, the quadratic programming algorithm needs to use linear algebra optimally.

The solution to a convex equality-constrained quadratic program can be written in closed form. The closed form expression can be directly used to compute the Lagrange multipliers of the binding constraints. This value of the multipliers can then be plugged into another formula to compute the values of the optimization variables. This is the standard reduced formula described in textbooks.

Two co-pending applications, “Real-Time Quadratic Programming For Control Of Dynamical Systems,” Ser. No. 10/308,285, filed Dec. 2, 2002, and “System and Method of Accelerated Active Set Search for Quadratic Programming in Real-Time Model Predictive Control,” Ser. No. 10/367,458, filed Feb. 14, 2003, the assignee of which is the assignee of the present invention, describe how the standard procedure can be adapted for the case when degeneracy is present in the equality constraints. However, this method has the shortcoming that the inaccuracy in the multiplier computation propagates to the computation of the optimization variables (control variables), resulting in extremely undesirable constraint violations. Such constraint violations can cause great damage to the operation of the dynamical system.

### SUMMARY OF THE INVENTION

The present invention provides an algorithm and apparatus for controlling a dynamical system in real-time, by providing the ability to produce a solution that retains feasibility with respect to the equality constraints despite degeneracy in the constraints, without introducing any extra matrix factorization.

The main purpose of solving this problem is to determine which of the inequality constraints are binding, i.e., are preventing the optimization variables from improving on the current value of the objective, and which constraints are not. The ones that are not binding can be dropped from the active set, and the objective function improved. This determination of which constraint to keep and which to drop is made by examining the sign of the Lagrange multipliers of the equality constraints.

The existing method for solving this problem produces accurate results when the constraints are all non-degenerate, i.e. are linearly independent. In the event of degeneracy the inaccuracy in the computed value of the multipliers is propagated to the value of the optimization variables. This causes the equality constraints to be violated and often results in critical errors such as the violation of a constraint bound or actuator limit.

The method of the present invention proposes a “change of variables” which enables the solution procedure to honor the equality constraints even when degeneracy is present, while computing the multipliers at the same level of accuracy as the old method. Moreover, the new method achieves this extra accuracy without performing any additional matrix factorization and without increasing the worst-case complexity of the computation.

### BRIEF DESCRIPTION OF THE DRAWINGS

Other advantages of the present invention will be readily appreciated as the same becomes better understood by reference to the following detailed description when considered in connection with the accompanying drawings wherein:

The FIGURE illustrates one type of control system that uses the quadratic programming method of the present invention.

### DETAILED DESCRIPTION OF A PREFERRED EMBODIMENT

The Generic Problem

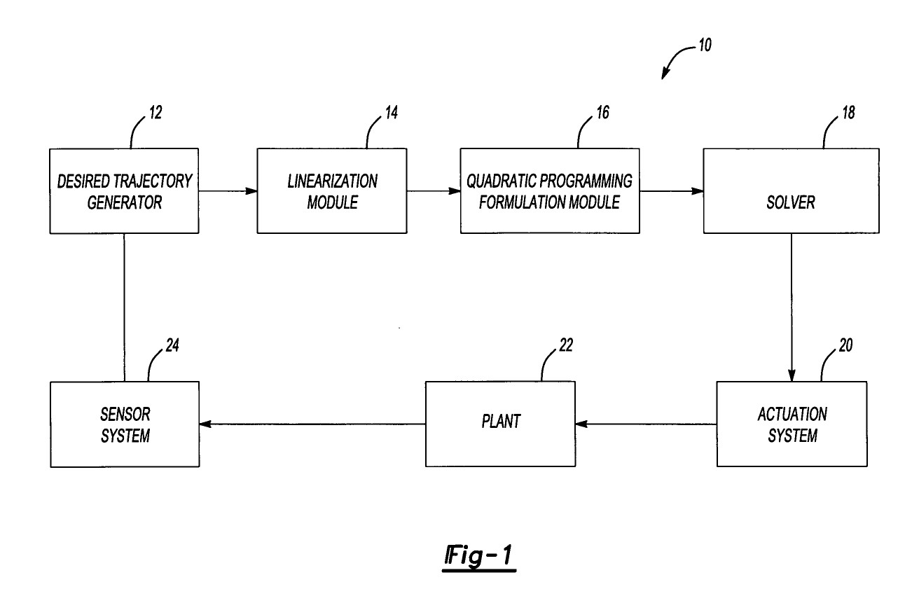

FIG. 1 is a generic model of a control system 10 using Model Predictive Control and of a type that would benefit from the present invention. The control system 10 includes a desired trajectory generator 12 which creates a desired profile of the outputs of the system 10. A linearization module 14 derives a linearized model about the desired trajectory from the desired trajectory generator 12. A quadratic Programming formulation module 16 forms a quadratic program to determine a control profile for best attaining the desired trajectory while respecting any constraints. The Solver 18 solves the optimization problem established by the formulation module 16 to generate a profile of the optimal controls. The Solver 18 is the focus of this invention. The profile of the optimal controls is sent to an actuation system 20, which acts on the plant 22 of the system 10. The sensor system 24 provides feedback from the plant 22 to the desired trajectory generator 12.

The forthcoming formulation of the optimization problem for the MPC is included here only for the sake of completeness. To further simplify the presentation, we have considered only a “one-time step ahead” MPC, or the constrained dynamic inversion problem, elaborated in U.S. Pat. No. 6,882,889. The full MPC problem can also be formulated and solved using the active set method described in “System and Method of Accelerated Active Set Search for Quadratic Programming in Real-Time Model Predictive Control,” Ser. No. 10/367,458, filed Feb. 14, 2003. The following formulation is only one possible representation of the Model-Predictive control problem, intended to illustrate how we get to a Quadratic Program, and not to claim an innovation in deriving the Quadratic Program.

Consider a dynamical system with state variables ξ, control variables u, and outputs y, described by the linearized system as below (this can be a linear system, or the linearized version of a nonlinear dynamical system):

$$\frac{ⅆ ξ}{ⅆ t} = {A}_{1} ξ + {B}_{1} u \\ y = C ξ + Du \qquad ( 1 )$$

We would like to determine how to deliver a change in control so that we achieve a desired change in the outputs. The problem is best handled in the discrete time version of the above linear system, where the subscript t represents each discrete time point:
Δξₜ=A₁ξₜ₋₁+B₁uₜ₋₁
Δyₜ=CΔξₜ+DΔuₜ (2)

Here Δuₜ=uₜ−uₜ₋₁ represents the change in the control variable required to produce a desired change Δyₜ=v in the outputs.

The quadratic objective we can minimize to achieve this is
(Δyₜ−v)^{T}V(Δyₜ−v)

The minimization must be performed subject to the system equations (2) being satisfied. Here V represents a diagonal matrix of positive weights on the each of the output goals. We also add similar goal terms for the state variables and control variables. These secondary objectives have small, but always non-zero weights, to preserve strict convexity of the problem.

The equality constraints posed by the system equations (2) can be eliminated by substituting Δξₜ=A₁ξₜ₋₁+B₁uₜ₋₁ in the second equation in (2), thereby deriving
Δyₜ=DΔuₜ+CA₁ξₜ₋₁+CB₁uₜ₋₁ (3)

This establishes that the change in outputs can be expressed solely in terms of Δuₜ. Additional inequality constraints on the outputs and inputs, including physical limits and rate limits, can also be expressed all in terms of Δuₜ in the form
AΔuₜ≦b (4)

The Quadratic Program

Combining the objective and the constraints, we arrive at a strictly convex quadratic program (QP). After replacing the optimization variable Δuₜ with x to avoid cumbersome notation, we can write the QP as below:

$$min \frac{1}{2} {x}^{T} Hx + {c}^{T} x \\ . Ax \leq b$$

subject to

Algorithm for Searching for the Optimal Active Set

Active set algorithms search iteratively for the set of binding constraints at optimality, usually referred to as the active set. For model-predictive control problems, the solution to the MPC problem in the current time step provides a guess for the optimal active set in the next time step. This particular guess is used to great advantage to cut down on the number of iterations required for solving the QP to convergence, a feature that is practically indispensable in real-time control. The broad steps of the active set algorithm are sketched below, and the associated linear algebra is elaborated in the following section.
Start off with a guess for an active set. We will denote the set of indices of constraints in the active set by W, and also characterize by E the rows in the constraint matrix A corresponding to the guessed active set. Assume a feasible point x_{f} is known, i.e., Ax_{f}≦b.
In iteration k, given a guess E for the active constraints, solve the Equality-Constrained QP (EQP)

$${min}_{x} \frac{1}{2} {x}^{T} Hx + {c}^{T} x \\ s . t . Ex = r , \qquad ( 7 )$$

where r represents the sub-vector of right hand sides for the active constraints. The optimal solution x*, and Lagrange multipliers λ* are given by

$$[ \begin{matrix}H & {E}^{T} \\ E & 0\end{matrix} ] [ \begin{matrix}{x}^{*} \\ {λ}^{*}\end{matrix} ] = [ \begin{matrix}- c \\ r\end{matrix} ] \qquad ( 8 )$$

Ratio Test Determine largest αε[0,1] such that xₖ₋₁+αs is feasible, where s=x*−xₖ₋₁, and xₖ₋₁ denotes the prior iterate. In other words, α is picked to be the largest value in [0,1] such that Axₖ₋₁+αAs≦b. This test need not be performed for constraint indices i that are in the active set, since they have Asᵢ=0 (or Asᵢ≦0 in iteration 1), and the prior iterate xₖ₋₁ is feasible. (footnote: It is possible to have degenerate constraints not in the active set that have Asᵢ=0, and the ratio test over such constraints would also be skipped.) Thus α is given by

$$α = {min}_{i ∉ W} \frac{{b}_{i} - ( {Ax}_{k - 1} ) i}{{As}_{i}}$$

Update the guess for the active set in the next iterate.
Add to W the first index i_{B} corresponding to which α achieves its minimum value in the ratio test, the guess for the active indices in the next iterate. The corresponding constraint is loosely referred to as the ‘tightest constraint’.
If there exist constraints for which the Lagrange multiplier λ* in the EQP (7) is negative, drop the constraint with the most negative multiplier from the active set. This is the so-called steepest edge rule. Bland's Rule is deployed whenever degeneracy is detected in the active set, and in these instances, the first constraint with a negative multiplier is dropped. Details on treatment and detection of degeneracy appear later in this disclosure.
Special case for first iteration Define a constraint in the initial active set to be consistent if the constraint is binding at x_{f}. If in the first iteration α<1, then all constraints that are not consistent are dropped, irrespective of the sign of their multiplier. This is because if Ex_{f}≦r with strict inequality for some components, the updated iterate x₁=x_{f}+α(x*−x_{f}) does not satisfy Ex₁=r for all constraints in the active set for the next iteration, leading to a discrepancy. This is the consistent active set method (described in earlier patent) For example, if x_{f} is in the strict interior of the feasible set, this could lead to dropping all the constraints and re-starting with an empty active set, thereby allowing little exploitation of ‘hot start’. However, if x_{f} is the set of optimal controls obtained by solving the MPC problem at the prior time step, it is usually consistent with the initial guess for the active set.
The Inconsistent active set method (described in earlier patent) In some cases, the known feasible point is largely inconsistent with the starting guess for the active set. This leads to many inconsistent constraints being dropped from the active set at the end of the first iteration. If the initial hot start guess is a good one, many iterations are wasted in picking these constraints back up. Thus another approach is to retain the inconsistent constraints in the active set and continue the search for the optimum even though the iterate and the active set disagree. This inconsistency disappears if in any iteration α=1. Moreover, the degree of inconsistency reduces at every iteration. The inconsistent method usually allows far more rapid convergence to the optimum than the consistent method.

Update the iterate
xₖ=xₖ₋₁+αs

Convergence to the global optimum is achieved when α=1 and λ*≧0, i.e., when the active set does not change.

If the allowed time within the real-time interval is exhausted before convergence is reached, the last updated iterate is returned as the solution.

This invention describes novel ways of solving the Equality Constrained QP (7) in the above active set algorithm. The EQP in iteration k+1 can be expressed as:

$${min}_{s} \frac{1}{2} {( {x}_{k} + s )}^{T} H ( {x}_{k} + s ) + {f}^{T} ( {x}_{k} + s ) \\ s . t . E ( {x}_{k} + s ) = {b}_{e} \qquad ( 1 )$$

Here xₖ is the value of the vector of optimization variables in the preceding iterate.

Case 1: xₖ satisfies Exₖ=bₑ

Since xₖ satisfies the right hand side of the equalities exactly (if not, alternative described later), the EQP in s can be re-written as

$$min \frac{1}{2} {s}^{T} Hs + {s}^{T} ( {Hx}_{k} + f ) \\ Es = 0 \qquad ( 2 )$$

While the EQP in either form can be solved exactly in the absence of degeneracy, the presence of numerical degeneracy (even though there may not be degeneracy in infinite precision) causes inaccurate solutions. In particular, with the usual way of reducing the KKT equations, determining lambda first, and plugging the solution back in to compute the (change in) controls, the equality constraints can be violated, causing very undesirable constraint violations further in the QP iterations.

This document proposes an alternate way of solving the EQP, based on a ‘change of coordinates’. This ‘change of co-ordinates’ to take advantage of the reduced nullspace formulation is more standard in the nonlinear programming literature. It involves more linear algebra but is guaranteed to not violate the equality constraints. The novelty in what is proposed here is how it can all be accomplished without doing any extra matrix factorization.

What is needed is a basis for the nullspace of E. While this can be computed by a QR factorization of E^{T}, this factorization cannot be re-used in computing the multipliers. The trick is to recognize that the OR factorization of L⁻¹E^{T} can be used to recover the nullspace of E, since L is non-singular (L is the triangular Cholesky factor or “square root” of H, i.e. H=LL^{T}. The Cholesky factor is already available,). The following steps will give us a nullspace for E, and simultaneously provide the necessary ingredients for solving for λ.
1. Compute M^{T}=L⁻¹E^{T} (sequence of back-solve of triangular LM^{T}=E^{T}).
2. Compute a QR factorization of M^{T}=L⁻¹E^{T}. Note that whenever we mention this QR, we will assume that while computing successive Householder transformations we identified small pivots and removed the corresponding rows of M, and hence rows of E as degenerate. Thus the “E” that remains has non-degenerate rows only, and the resulting R has pivots that are large enough to appear in the denominator of a floating point division without causing any unacceptable inaccuracy.

Let the columns of Q be split as Q=[Y|Z], where Y refers to the columns corresponding to non-zero diagonal elements in R, and Z the remaining columns. Let U represent the nonsingular upper triangular block of R (corresponding to the columns Y). Then we can split up L⁻¹E^{T} as
L⁻¹E^{T}=QR=YU+Z[0] (3)

While the columns of Y provide a basis for the range of the matrix L⁻¹E^{T}, the columns of Z provide a basis for its orthogonal complement, the nullspace of the transpose of L⁻¹E^{T}, which is the same as the nullspace of EL^{-T}. Since L is non-singular, the columns of L^{-T}Z must then constitute a basis for the nullspace of E. Thus the set of vectors satisfying the EQP equality constraints Es=0 can alternately be expressed as
{s:Es=0}={s=L^{-T}Zr:rε^{dim(Z)}}

Substituting H=LL^{T} in the original EQP objective, we get

$${min}_{s} \frac{1}{2} {s}^{T} {LL}^{T} s + {s}^{T} {LL}^{T} {x}_{k} + {s}^{T} f$$

Further substituting L^{T}s=Zr gives us an unconstrained version of the EQP in the new variables r

$${min}_{r} \frac{1}{2} {r}^{T} {Z}^{T} Zr + {r}^{T} {Z}^{T} ( {L}^{T} {x}_{k} + {L}^{- 1} f )$$

The unconstrained solution for the above objective can be computed without any extra factorization, because since the columns of Z are orthonormal, Z′*Z is the identity. Thus the solution in r is simply given by
r=−Z^{T}(L^{T}xₖ+L⁻¹f) (4)

Therefore, the solution to the EQP in the original variables is given by
s=L^{-T}Zr=−L^{-T}ZZ^{T}(L^{T}xₖ+L⁻¹f) (5)

No extra factorization is necessary, only a few backsolves and forward solves with the available Cholesky factor L are needed. These backsolves/forward solves grow only as a square of the matrix dimension, whereas any factorization procedure grows as the cube.

The optimal multipliers are computed as the solution to the system
EH⁻¹E^{T}λ=−EH⁻¹(f+Hxₖ) (6)

Given that H=LL^{T}, we have
EL^{-T}L⁻¹E^{T}λ=−EL^{-T}L⁻¹f−Exₖ (7)

Given the result from our earlier QR factorization, L⁻¹E^{T}=YU,
U^{T}Y^{T}YUλ=−U^{T}Y^{T}L⁻¹f−Exₖ
which, along with the fact that Y′*Y is the identity, gives
U^{T}Uλ=−U^{T}Y^{T}L⁻¹f−Exₖ (8)

(Note that for a consistent active set method Exₖ=bₑ, the constraint right hand side).

Since U is non-singular, the equation for λ boils down to
Uλ=−Y^{T}L⁻¹f−U^{-T}Exₖ (9)

which requires a simple extra forward solve with the transpose of an upper triangular matrix (we already have L⁻¹f).

The real distinction between the old method and the current arises when there is degeneracy, i.e., some of the rows of E are dependent. In pre-existing methods, including those described in some of the earlier patents referenced herein, the QR factorization of E*inverse(H)*E′ would then yield zeros on the diagonal positions of R, and the corresponding value of lambda would be set to zero. In finite precision arithmetic, any diagonal element value below a tolerance, say 1e-8, would be set to zero, as would be the corresponding multiplier since division by such a small number would cause problems. This value of λ plugged back in to compute u would cause inaccuracy in the computed value of u, which would then violate the equality constraints. One may say that lowering the tolerance would cause λ to be more accurate, and the resultant u accurate. But if the tolerance is lowered, to say 1e-16, to allow for more accurate λ, the value of the corresponding multiplier could be of the order 1e16, and this could cause other numerical inaccuracies, particularly when propagated to u.

In contrast, in the method proposed here, the output of the QR factorization of L⁻¹E^{T} is mainly used to compute the nullspace of E. In this case, the tolerance should be set very low (say 1e-16) in picking which columns of Q are part of Z and form a basis for the nullspace. By setting the tolerance low, we are being conservative in deciding whether a column of Q is in the nullspace. This guarantees that all the columns of Z are in the nullspace, and EZ=0, so that the s computed through the proposed change of variables does not violate the constraint right hand side. This can, of course, result in some extremely small diagonal pivots in U, which are then used to compute the multipliers. But since the sign of the multipliers and not necessarily their value is of consequence, and since the computed λ is not plugged back in to compute the controls, the damage from this inaccuracy in the event of degeneracy is significantly less than in the old method. And this is the first method to provide such an ‘error control’ mechanism.

Alternate Case 2: xₖ does not satisfy Exₖ=bₑ

If the previous xₖ does not satisfy the right hand side of the equalities exactly, a separate approach needs to be adopted. A novelty of this invention is that we can solve this problem as well without computing any extra factorization.

Revisiting the previous formulation (1), we can express the original EQP as

$$min \frac{1}{2} {( {x}_{p} + s )}^{T} H ( {x}_{p} + s ) + {f}^{T} ( {x}_{p} + s ) \\ s . t . E ( {x}_{p} + s ) = {b}_{e} \qquad ( 10 )$$

where xₚ is any solution (p stands for “particular” solution) satisfying the linear system of equations Ex=bₑ, and not necessarily the preceding iterate. Once xₚ is determined, the method described earlier can be applied easily. The novelty in this invention is that it devises a way of using the factorization we would have computed anyway to support our subsequent calculations to compute this particular solution.

Since E is underdetermined, we can compute a particular solution to the system
Exₚ=bₑ (11)

by using the “minimum-norm approach” well-known in textbooks. The novelty here is to use the factorizations that we had computed anyway. We can re-write (11) as
EL^{-T}L^{T}xₚ=bₑ (12)

and use (3) to substitute in the QR factorization, obtaining
R^{T}Q^{T}L^{T}xₚ=bₑ (13)

We can solve (13) as follows. First of all, we forward solve the lower triangular system
R^{T}z₁=bₑ (14)

Since R^{T} is underdetermined, with a square non-singular block, we pad the indeterminate variables in z₁ with zeros.

Then we compute L^{T}xₚ as z₂=L^{T}xₚ=Qz₁ (since Q is orthogonal).

Finally we obtain xₚ as
xₚ=L^{-T}z₂ (15).

Now the rest of the computation is exactly similar to the method described earlier, with the exception of r in (4). Computing r now looks like
r=−Z^{T}(L^{T}xₚ+L⁻¹f) (16)

It turns out that with our special choice of xₚ, the first term in the above is zero, i.e. Z^{T}L^{T}xₚ=0, and hence for this method r=−Z^{T}L⁻¹f

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers for steps in the method claims are for ease of reference by dependent claims, and do not indicate a required sequence, unless otherwise indicated.

What is claimed is:

1. A method for solving an Equality-constrained Quadratic Program (EQP) having a plurality of optimization variables, Lagrange multipliers and a plurality of constraints, the method including the steps of:
a) removing degenerate constraints from the plurality of constraints in the process of computing the solution; and
b) determining values of the optimization variables independently of values of the Lagrange multipliers; and
c) determining values of the Lagrange multipliers independently of values of the optimization variables.

2. The method of claim 1 wherein said steps b) and c) are performed with a single matrix factorization.

3. The method of claim 1 wherein there is no known set of values of the optimization variables that satisfies the plurality of constraints.

4. The method of claim 1 wherein the EQP is given by:
$${min}_{x} \frac{1}{2} {( x + s )}^{T} H ( x + s ) + {f}^{T} ( x + s )$$
$$s . t . E ( x + s ) = {b}_{e}$$
wherein x is the vector of optimization variables in the preceding iterate, and x is available and satisfies the constraints Ex=bₑ.

5. The method of claim 1 wherein the EQP is given by:
$${min}_{x} \frac{1}{2} {( x + s )}^{T} H ( x + s ) + {f}^{T} ( x + s )$$
$$s . t . E ( x + s ) = {b}_{e}$$
wherein x is the vector of optimization variables in the preceding iterate and x does not satisfy Ex=bₑ.

6. The method of claim 5 wherein said steps b) and c) are performed using only one matrix factorization.

7. The method for the problem in claim 4 further including the steps of:
a) computing a QR factorization of L⁻¹E^{T}, where L is the lower triangular Cholesky factor of H; and
b) recovering a nullspace of E based upon said step c).

8. The method of claim 7 further including the step of:
c) removing rows of E as degenerate.

9. The method of claim 8 further including the step of:
d) determining the QR factorization given by
L⁻¹E^{T}=QR=YU+Z[0]
where Y refers to the columns corresponding to non-zero diagonal elements in R, and Z the remaining columns; and U represents the nonsingular upper triangular block of R (corresponding to the columns Y).

10. The method of claim 9 further including the step of using the factorization in step h) to execute the following sequence of calculations:
r=−Z^{T}(L^{T}xₖ+L⁻¹f) (4)
Therefore, the solution to the EQP in the original variables is given by
s=L^{-T}Zr=−L^{-T}ZZ^{T}(L^{T}xₖ+L⁻¹f) (5)

11. The method of claim 10 further including the steps of:
Computing the optimal multipliers as the solution to the system:
EH⁻¹E^{T}λ=−EH⁻¹(f+Hxₖ) (6)
given that H=LL^{T},
EL^{-T}L⁻¹E^{T}λ=−EL^{-T}L⁻¹f−Exₖ (7)

12. The method of claim 11 further including the step of calculating values of the Lagrange multipliers from:
Uλ=−Y^{T}L⁻¹f−U^{-T}Exₖ (9)

13. A method for solving an Equality-constrained Quadratic Program (EQP) having a plurality of optimization variables, Lagrange multipliers and a plurality of constraints, the method including the steps of:
a) removing degenerate constraints from the plurality of constraints in the process of computing the solution;
b) determining values of the optimization variables independently of values of the Lagrange multipliers;
c) determining values of the Lagrange multipliers independently of values of the optimization variables; and
d) wherein said steps b) and c) are performed using a single matrix factorization.

14. The method of claim 13 wherein there is no known set of values of the optimization variables that satisfies the plurality of constraints.

15. The method of claim 14 wherein the EQP is given by:
$${min}_{x} \frac{1}{2} {( x + s )}^{T} H ( x + s ) + {f}^{T} ( x + s )$$
$$s . t . E ( x + s ) = {b}_{e}$$
wherein x is the vector of optimization variables in the preceding iterate, and x is available and satisfies the constraints Ex=bₑ.

16. A model predictive control system comprising:
a desired trajectory generator for creating a desired trajectory;
a linearization module deriving a linearized model about the desired trajectory;
a quadratic programming module in each of a plurality of time steps formulating a problem of achieving the desired trajectory for a multiple timestep window as a solution to a quadratic programming problem;
a solver for solving an Equality-constrained Quadratic Program (EQP) established by the quadratic programming module to generate a profile of optimal controls, the EQP having a plurality of optimization variables, Lagrange multipliers and a plurality of constraints, the solver removing degenerate constraints from the plurality of constraints in the process of computing the solution, the solver using a single matrix factorization to determine values of the optimization variables and values of the Lagrange multipliers independently of one other.
